(19) United States
(12) Patent Application Publication
(10) Pub. No.: US 2017/0142956 A1
(43) Pub. Date: May 25, 2017

(54) Utility Walk-Behind Vehicle for Agriculture and Property Maintenance

(71) Applicant: Paul A. Andruk, Hanson, MA (US)

(72) Inventor: Paul A. Andruk, Hanson, MA (US)

(21) Appl. No.: 14/947,195

(22) Filed: Nov. 20, 2015

(51) Int. Cl. A01M 7/00; B60L 11/18; B60L 11/06; B05B 13/00; B62D 51/04; B62D 51/00; B05B 9/00; A01C 23/04; B60L 11/12

(52) U.S. Cl. CPC A01M 7/0014; A01C 23/047; B60L 11/1805; B60L 11/06; B60L 11/12; B62D 51/04; B62D 51/001; B05B 9/007; B05B 13/005; B60L 2200/40; B60Y 2200/225

(57) ABSTRACT

Disclosed is a self-powered vehicle utilized in the field of agriculture, property maintenance, landscaping for use with estate or condominium ground maintenance. It is used for spraying pesticides, herbicides, fertilizer and the like and also for application of similar products in granular form, but further serves as a maintenance platform around a larger industrial facility. Its main payload area is also used for cargo and product transport. It offers high mobility and maneuverability. It is powered with gearhead motors connected to its drive wheels with batteries as its power source. They are charged by an engine driven generator all of which is mounted on the vehicle. Directional control is achieved by the use of a motorcycle handle bar in combination with rotary potentiometers. Each potentiometer controls pulse width of a pulse width modulator thereby controlling the speed of a gearhead motor. The vehicle is optionally a walk behind device but may be provided with a seat behind the handle bar.

### BACKGROUND OF THE INVENTION

1. Field of the Invention

The present invention relates to the field of agriculture, property maintenance and landscaping, such as estate or condominium ground maintenance. More specifically is a self-powered vehicle and is primarily used for spraying pesticides, herbicides, fertilizers and the like and application of similar products in granular form, but also is used as a maintenance platform in and around a larger industrial facility. The main pay load area is used as a cargo and product transport around such a facility. It transports and transfers liquids such as lubricants, pumps and remove waste liquids from any site with a self contained system. The compact design offers high mobility and maneuverability in areas enclosed by trees and bushes, plus it is light weight and portable. The vehicle is similar to a hybrid in that is electrically powered with gearhead motors directly connected to its drive wheels and having as a power source batteries, but the batteries are charged using an internal combustion engine driven generator all of which is mounted on the vehicle. The internal combustion engine is intended to be converted to LP or LNG, thus making the vehicle suitable for indoor use such as liquid pesticide and liquid fertilizer applications for greenhouse or a fully enclosed environments using artificial light for any type of plant propagation. Another option is the addition of a spray wand applicable for the number of individual species that require the use of different compounds for pest control and the like.

A key feature of the invention relates to the fact that it is electrically powered. That is because some of its use relates to the use of the vehicle in the application of pesticides, herbicides and the like in cranberry agriculture that is very sensitive to concentration of these additives. The use of electrical power allows very precise control of speed of the vehicle that is vital to control of the concentration of the additives.

The rising popularity of buying food from a local farm stand has spawned small farms producing a wide range of crops. Tree fruits and small fruits such as grapes and raspberries are grown on trellises and hedge rows whereas vegetables and strawberries are grown as row crops. The present invention provides an economical alternative to a farm tractor and the wide range of implements needed to perform tasks such as liquid and granule pesticide applications where only small volumes for small areas have specific needs. The present invention also provides a quiet environmentally friendly machine in use around a farm stand that is very appealing to the public.

One particular product in an agricultural application concerning which the present invention has been very useful is the raising of cranberries. What follows is merely an example of its use and it is not intended as any limitation.

Cranberries are a naturally occurring North American food product first used for food by Native Americans. They are grown in a number of North American U.S. states, particularly Massachusetts, and also in a number of Canadian provinces. Native Americans introduced English settlers in Massachusetts to cranberries that were incorporated into traditional Thanksgiving feasts.

Historically, cranberry agriculture has been in wetlands frequently referred to as bogs. The cranberry beds are disposed in terrain that can be flooded for purposes of protection of the vines from low temperatures and also for purposes of harvesting the products, but the vines mature above the water level. The growing season commences in the spring and harvesting is in September through the first part of November. Harvesting is either wet picked or dry picked with most of the harvesting being wet picked. To harvest cranberries the beds are flooded with 6 to 9 inches of water above the vines and a harvester is driven through the beds to remove the fruit from the vines. Harvested cranberries float in the water and can be corralled into a corner of the bed and conveyed or pumped from the bed. Dry picked cranberries involve higher labor cost and lower yield but the dry picked berries are less bruised and can be sold as fresh fruits instead of having to be immediately frozen or processed.

2. Description of the Prior Art

The following references were disclosed by a search of the prior art. The most relevant appears to be Meyer, U.S. Pat. No. 5,642,677 for a Walk-Behind Self-Propelled Multi-Functional Nursery Device. While it is similar in some respects to the present invention it also differs in very material aspects. It has nothing whatever to do with cranberry agriculture.

Another reference include Mclvor-Dean et al, U.S. Pat. No. 5,467,723 for a Combined Cultivator and Fluid Injector System. Its purpose is subsurface application of fluid to a field which, of course, makes it unsuitable for the application of sprayed pesticide, herbicides and liquid fertilizer and application of granule.

Another reference is Wiese et al, U.S. Pat. No. 7,121,040 for a Combination Foliage Compaction and Treatment Method and Apparatus. This reference teaches a method and apparatus for applying liquid to foliage and includes adjustable spraying nozzle apparatus. This invention contemplates attachment to the back of a self-propelled vehicle that is not part of the invention or mounting of wheels to be towed behind or pushed in an agricultural field.

The final reference disclosed is Jackson, U.S. Pat. No. 4,664,340 and is entitled simply “VEHICLES.” It is a stabilization system for hover vehicle free-flying or cable-controlled helicopters or ducted vehicles. It is used to control the height of a flying vehicle above the ground and can be used in combination with apparatus for electrostatic spraying of crops such as paddy rice.

None of these references teach or suggest the present invention.

### SUMMARY OF THE INVENTION

Bearing in mind the foregoing, it is a principal object of the present invention to provide an electrically powered environmentally friendly walk-behind vehicle for the spraying of pesticides, herbicides, fertilizers and other related compositions in the fields of agriculture, property maintenance and landscaping.

Another related principal object of the invention is to provide a hybrid aspect of the foregoing utilizing an internal combustion powered electric generator for recharging batteries powering the foregoing vehicle.

A further related object of the invention is that use of an electrical power system allows for extremely precise speed control that is vital in certain spraying applications.

Another object of the invention is to provide a walk-behind vehicle supported on four wheels, two of which are equipped with electrically powered gearhead motors to provide a driving force to those two wheels, with the other two wheels swivelable and their direction being controlled by a motorcycle type handle bar that includes a twist throttle such as used on motorcycle handle bars, and controls differential speed between the two rear wheels to control direction of the vehicle.

A further object of the invention is to provide a bank of electrical storage batteries, accompanying electrical wiring and circuitry in various related electrical controls, which batteries are recharged by the internal combustion engine driven generator.

An additional object of the present invention is its use as a maintenance platform wherein the main pay load area is used as a cargo and product transport and transfers liquids such as lubricants, pumps and remove waste liquids from any site with a self contained system.

Another object of the present invention is that its compact design offers high mobility and maneuverability in areas enclosed by trees and bushes, plus it is lightweight and portable.

A further object of the present invention is that it offers the option of converting the internal combustion engine to LP or LNG, thus making the vehicle suitable for indoor use such as liquid pesticide and liquid fertilizer applications for greenhouse or a fully enclosed environments.

An additional object of the present invention is another option of the addition of a spray wand applicable for the number of individual species that require the use of different compounds for pest control and the like.

Other objects and advantages will be apparent to those skilled in the art upon reference to the following descriptions and appended drawings.

In accordance with a primary aspect of the present invention there is provided an agriculture, property maintenance and landscaping utility vehicle principally intended for spraying pesticides, herbicides and fertilizers but suitable for alternative tasks. It is comprised of a walk-behind electrically powered four wheeled vehicle which is electrically powered using reversible gearhead motors connected through a sprocket and chain mechanism to two drive wheels at the rear of the vehicle with two freely swiveling castor wheels at the front of the vehicle. The gearhead motors are driven in the first instance by DC power supplied by storage batteries which, in turn, are recharged by a generator mounted on the vehicle. Powering the generator is an internal combustion engine, or an alternative LG or LNG engine. The direction of the vehicle is steered using a conventional motorcycle handle bar which is connected through a linkage to adjust the relative speed of the two rear wheels. The handle bar supports a number of controls including a twist throttle for speed control and various switches for the electrical circuitry. The vehicle includes a main pay load area on which is initially mounted a tank for containing pesticide or related materials which is connected to spray apparatus in the first instance on the front of the vehicle. But the tank and front end spray apparatus can be readily removed to accommodate other tasks such as a cargo and product transport, for transfer of liquids such as lubricants, pumps, and removal of waste liquids from any site with a self contained system.

### BRIEF DESCRIPTION OF THE DRAWINGS

Various other features of the invention will become apparent to those skilled in the art from the following discussion taken in conjunction with the appended drawings, in which:

FIG. 1 is a top plan schematic view of the inventive utility vehicle illustrating the principal aspects thereof.

FIG. 2 is a rear elevation view of the utility vehicle showing the vehicle controls, storage battery and generator, rear drive wheels and drive combo system linkage.

FIG. 3 is a left side perspective drawing showing the removable spray apparatus attached to the front of the vehicle, swivable castor front wheels, rear drive wheels, handle bar control, electric storage batteries and generator, removable pesticide storage tank and electronics board.

FIG. 4 is a top view of a Rotary HMI (human machine interface) that is a speed control for each of two gearhead motors that each drive a drive wheel. Directional control of the vehicle is obtained by differential speed of each drive wheel compared to the other.

FIG. 5 is a rear elevation view of the Rotary HMI of FIG. 4.

FIG. 6 is an overhead view of an old cranberry bog showing how the present invention could be employed advantageously in the application of liquids and granules to the vines planted therein.

### DETAILED DESCRIPTION OF THE PREFERRED EMBODIMENTS

As required, a detailed embodiment of the present invention is disclosed herein; however, it is understood that the disclosed embodiment is merely exemplary of the invention that may be embodied in various forms. Therefore, specific structural and functional details disclosed herein are not to be interpreted as limiting but merely as a basis for the claims and as a representative basis for teaching one skilled in the art to variously employ the present invention in virtually any appropriately detailed structure.

Reference is now made to the drawings in which like characteristics and features of the present invention shown in the various figures are designated by the same reference numerals.

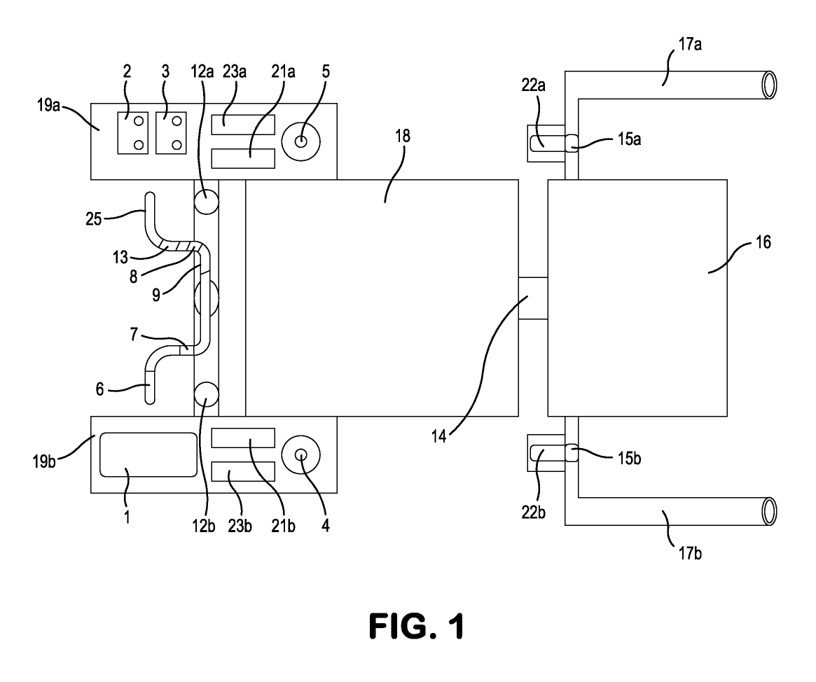

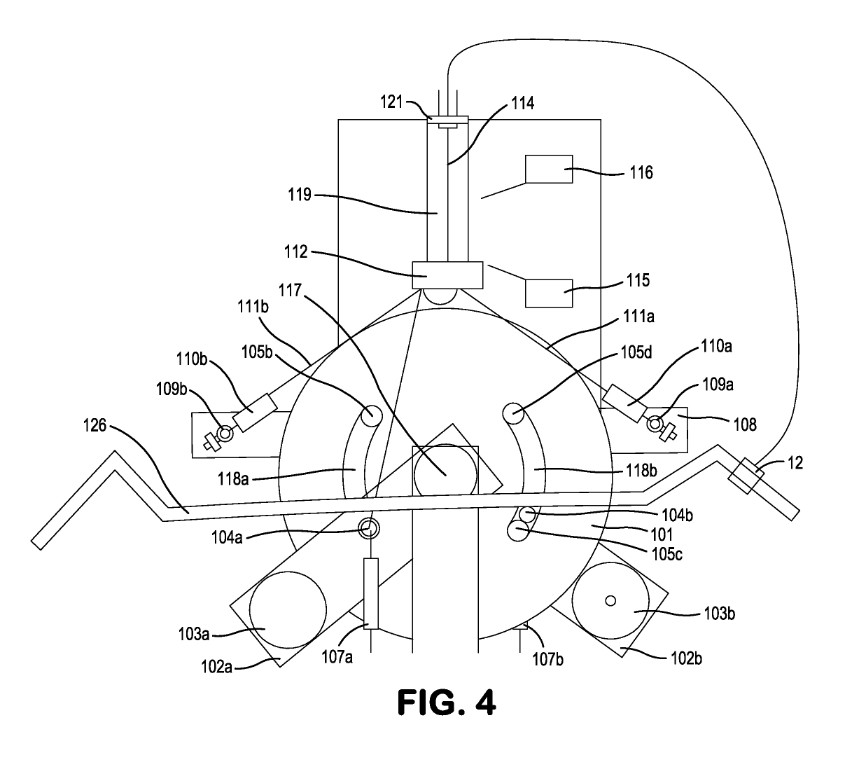

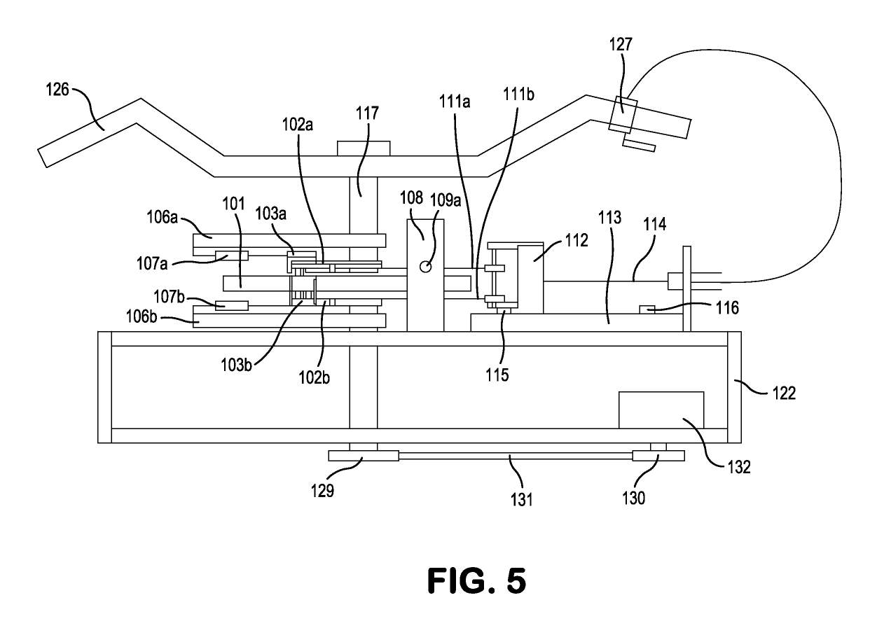

FIG. 1 is a top plan schematic view illustrating many of the components of the present invention. Internal combustion engine powered generator 1 and electric storage batteries 2,3 are shown on opposite sides of handle bar 25. Handle bar 25 is described in FIGS. 4 and 5 as handle bar 126, but it is the same as handle bar 25. Handle bar 25 includes twist throttle 6. Also seen is 24 volt variable speed reversible gearhead motors 12a, and 12b. The power transmission is done by roller chain drives 21a, 21b. The roller chain drive sprockets that are attached to gearhead motors 12a, 12b can be changed to different diameters to provide a different range of ground speed and torque to comply with different applications. Also seen is circuit C variac 5. Mounting brackets 19a, 19b are positioned to the rear of the drive wheels to assist with even weight distribution on drive wheels 23a, 23b by using the weight of generator 1 on one side and the weight of 12 volt automotive type batteries 2, 3 on the other side. Osculation pivot 14 provides even weight distribution, traction and steering between drive wheels 23a, 23b and castor wheels 22a, 22b. So are castor wheel axis shafts 15a, 15b on either side of the front of the vehicle. Castor wheels 22a, 22b swivel freely on the castor wheel vertical axis shafts 15a, 15b. The castor wheels 22a, 22b are smaller in diameter than drive wheels to provide more responsive steering, which is controlled by variable speed between the drive wheels 23a, 23b. The electronics board 16 is at the front of the vehicle between the castor wheel vertical axis shafts (15a, 15b) and behind that is the main payload area 18. The main payload area 18 is also positioned slightly forward of the center of the drive wheels. At the rear of the vehicle are drive wheels 23a, 23b and roller chain drive assembly 21a, 21b to power the drive wheels 23a, 23b. Mounted forward are apparatus 17a, 17b for supporting attachments such as removable pesticide spray equipment. Circuit C is supplied 115 VAC from generator (1) to circuit C variac (5). Said variac then feeds 85-115 VAC to a bridge rectifier unit mounted on the electronics board that produces an output current of 24-32 VDC. Said current supplies batteries 2, 3 which are connected in series. This supplies charging current and surplus current when the batteries 2, 3 are beyond capacity. A double pole double throw switch 13 isolates the current of battery (2) or battery (3) for continuous 12 VDC auxiliary output.

The power cutout, engage brakes switch 7 has 2 positions. In the run position all functions of the system are on line. In the stop position a 2 pole relay disconnects power to circuits A/B and C before the forward/reverse relay of each circuit and cuts the power to the clutch brakes in gearhead motors 12a, 12b which in turn engages both brakes. When said switch is in the stop position, the drive wheels are locked and the charging circuit remains online. 115 VAC, 24 VDC and 12 VDC are available for auxiliary use. Said switch also can be used for emergency situations. By rule, the switch is always set to the stop position before the operator leaves the controls.

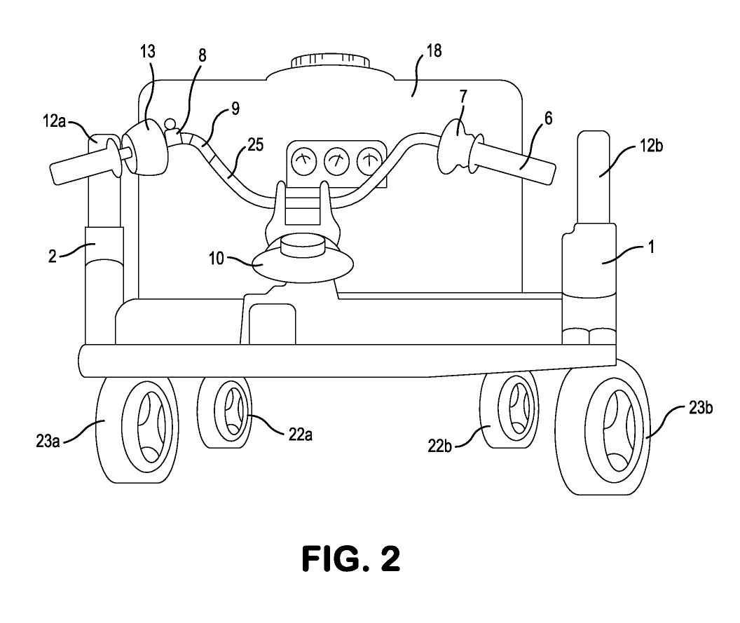

Turning to rear elevation view FIG. 2, generator 1 and storage battery 2 are shown on either side of handle bar 25, on which is mounted twist throttle 6. On either side are drive wheels 23a, 23b and castor wheels 22a, 22b. Above the handle bar 25 are 24 volt variable speed reversible gearhead motors 12a, 12b and battery isolator switch 13.

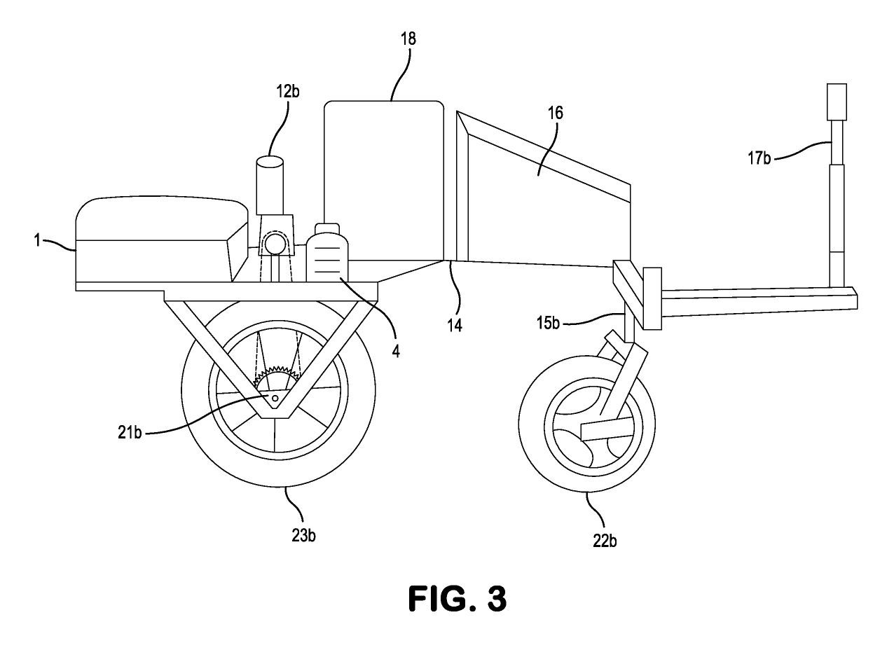

FIG. 3 is a left side perspective drawing showing generator 1 is near to 24 volt variable speed reversible gearhead motor 12b. Also seen underneath them is drive wheel 23b and roller chain drive assembly 21b. Osculation pivot 14 is between these components and castor wheel 22b and castor wheel vertical axis shaft 15b. At the front of the vehicle is apparatus 17b for supporting forward attachments.

FIG. 4 is a top view of a Rotary HMI (human machine interface) that is a speed control for each of two gearhead motors that each power a drive wheel. Directional control of the vehicle is obtained by differential speed of each drive wheel compared to the other. FIG. 5 is a rear elevation view of the Rotary HMI of FIG. 4.

### Overview of Rotary HMI

The rotary HMI is a mechanism which allows for speed control and directional control by varying the rotational speed between 2 variable speed DC gearhead motors propelling a vehicle. The prototype is in use on a self-propelled vehicle that has 2 drive wheels and 2 castor wheels. Speed control is done through a thumb lever or twist throttle control such as used on a motorcycle or ATV. This type of control can be used on a self-propelled or seated operator version of a vehicle. It could also use a foot pedal type speed control on a seated version only. Steering is done by rotating a pair of motorcycle type handle bar controlled by two hands or a lever controlled by a single hand on which the speed control device is attached. The prototype HMI operates 2 inexpensive rotary type potentiometers that control the pulse width of 2 individual pulse width modulators, one for each motor. This mechanism can also operate 2 rotary type hall effect modules such as used for speed control of an electric motorcycle or scooter to achieve more refined speed control from the pulse width modulators. Other attributes of this mechanism are as follows:

1: Offers proportionate directional control. It allows for more responsive turning at lower speeds for tight maneuvering such as navigating in tight areas as inside of buildings or loading or unloading on and off a trailer.

2: Does not over respond when the operator is travelling a distance at higher speeds or trying to maintain a straight line of travel.

3: Has a full system power disconnect to prevent accidental movement when the speed control is in the off position. The operator must be at the controls for the vehicle to move.

4: When navigating a straight line with the speed control at full, an override mechanism switches both potentiometers to corresponding rotary potentiometers used as trimmers. This allows the operator to synchronize the full speed of the 2 motors and adjust the full speed to allow the vehicle to perform tasks such as calibrating a liquid or granule application. It also facilitates maintaining a straight line of travel in such an application.

5: All moving parts are fully adjustable.

6: Can be easily modified to use linear type potentiometers.

7: Offers an alternative to a joystick that can be difficult to control in self-propelled applications when the operator is walking while controlling the vehicle.

8: The handle bar control version can have numerous other controls mounted in ergonomic positions.

9: The lever control version can allow for directional and speed control with one hand and the other hand is free to operate other controls.

10: Has a 3 position switch for the integral clutch brake control on the individual motors. With the switch in the OFF position, the main power disconnect and brakes are engaged and all controls are disabled. With the switch in the manual position, the brakes are controlled by a switch on the handle bar or lever and the power disconnect is controlled by the position of the speed control. This mode would be used under normal operation. With the switch in the auto position, the brakes engage in tandem with the power disconnect mechanism that is engaged when the speed control is released. This mode offers the operator more control when navigating in tight areas or navigating a steeper grade. When the speed control is released, the vehicle will come to a stop instantly.

The following description applies to both FIGS. 4 and 5. The primary component is the control gear 101 that rotates fixed to shaft 117. Said shaft is mounted to frame 122 and rotates at an equal ratio with the rotation of handle bar 126. The total rotation is 80 degrees, 40 degrees on each side of the handle bar 126 in the center position. Shaft 117 is shown mounted in the vertical position and control gear 101 in the horizontal position. This is noted for reference. Control arm 102a is mounted above control gear 101 on shaft 117 and control arm 102b is mounted below control gear 101 on shaft 117. Control arms 102a and 102b rotate freely on shaft 117. Rotary potentiometer with gear 103a is mounted with the body fixed to the upper side of control arm 102a and the rotating shaft with the gear is facing the underside and the teeth of the gear mesh with the teeth on the perimeter of control gear 101. Rotary potentiometer with control arm 103b is mounted with the body fixed to the underside of control arm 103b and the rotating shaft with gear is facing the upper side and the teeth of the gear mesh with the teeth on the perimeter of control gear 101. The gear ratio is such that control arms 102a and 102b will travel 40 degrees along the perimeter of control gear 101 to complete the 312 degrees of rotation of potentiometers 103a and 103b. Control gear 101 has 2 radial slots 118a and 118b positioned on opposite sides of the gear. Radial slot 118a has adjustable stops 105a and 105b mounted at opposite ends of the slot. Radial slot 118b has adjustable stops 105c and 105d mounted at opposite ends of the slot. Guide pin 104a is positioned in control arm 102a to move from end to end of radial slot 118a. Adjustable stops 105a and 105b are positioned in slot 118a to limit the travel of control arm 2a by making contact with guide pin 104a. This allows potentiometer 103a to complete its full rotation in both directions without damaging the internal stops of the potentiometer itself. Guide pin 104b and adjustable stops 105c and 105d perform the same function for control arm 102b. Return spring arm 106a is mounted fixed to shaft 117 above control arm 102a and return spring 107a is an extension spring connected from said arm to guide pin 104a. Return spring arm 106b is mounted fixed to shaft 117) below control arm 102b and return spring 107b is an extension spring connected from said arm to guide pin 104b. The tension of the return springs positions potentiometers 103a and 103b at zero speed control until acted upon by other forces. In this position both potentiometers are on the same side of the center of control gear 101. This side will be noted as rear.

Potentiometer 103a is the control resistor for the PWM (pulse width modulator) that controls the speed of the left side motor and drive wheel. Potentiometer 103b is the control resistor for the PWM that controls the speed of the right side motor and drive wheel. For the operator to control the speed and direction of the vehicle depends on the position of the control arms 102a and 102b. If both control arms 102a and 102b are dominated by the tension of return springs 107a and 107b, which positions said arms at the rear of the center of the control gear 101 and the end of travel is limited by guide pins 104a and 104b contacting stops 105a and 105c, the vehicle will remain stationary. If control arms 102a and 102b are simultaneously pulled toward the front of control gear 101 the vehicle will increase in speed proportionate to the position of the said control arms and maintain a straight line of travel. When said control arms are stopped by guide pins 104a and 104b contacting stops 105b and 105d, the vehicle will be at full speed traveling in a straight line. Directional control is done by control arms 102a and 102b being at 2 different points of the 40 degree travel range along the perimeter of control gear 101.

If control arm 102a was to be at 10 degrees of travel from the rear position and control arm 102b was to be at 30 degrees of travel from the rear position, the right wheel of the vehicle would be rotating three times faster than the left wheel and the radius of the left hand turn would be proportionate to that ratio. How this is achieved is further described.

At this point it must be noted that this description is in reference to the remote version of the Rotary HMI that indicates control gear 101 rotates in the opposite direction of handle bar 126 at an equivalent ratio. The direct and remote versions of this unit will be described further in this document.

The position of control arms 102a and 102b is achieved by a stationary mechanism mounted to frame 122 at the forward end of control gear 101 which pulls and releases the said control arms. When the handle bar 126 rotates control gear 101, control arms 102a and 102b are suspended in a stationary position relative to the position of the speed control. Potentiometers 103a and 103b are rotated along the perimeter of control gear 101 as it rotates between them until control arms 102a and 102b are held stationary by guide pins 104a and 104b contacted the corresponding adjustable stops. If the operator selects 50% speed, then the control gear 101 is rotated for left turn by the handle bar 126, the speed of the right wheel will increase and the speed of the left wheel will decrease at a proportionate ratio. This allows for highly responsive maneuvering of the vehicle. The stationary speed control mechanism will be further described.

Mounting block 113 is attached to frame 122. It is positioned at the front of control gear 101 with slot 123 aligned with shaft 117 and the center of return spring arms 106a and 106b when the handlebars 126 are in the center position. Sliding block with pulleys 112 slides in slot 123 toward and away from control gear 101. The pulleys mounted in sliding block 112 face control gear 101. The position of sliding block 112 is controlled by the operator selecting the position of thumb throttle 127 (an alternative to twist throttle 6 described in connection with FIG. 1) which pulls speed control cable 114. When the thumb throttle 127 lever is pushed, speed control cable 114 pulls sliding block with pulleys 112 away from the control gear 101. On sliding block 112, the upper pulley is horizontally aligned with control arm 102a and the lower pulley is horizontally aligned with control arm 102b. One end of control cable 111a is attached to guide pin 104a, then is routed around the upper pulley on sliding block 112. The other end of said cable is connected to adjustable mount 109a by tension spring 110a. One end of control cable 111b is mounted to guide pin 104b, then is routed around the lower pulley of sliding block 112. The other end of said cable is connected to mount 109b by tension spring 110b. Adjustable mount 109a is mounted to one end of control cable mount frame 108 and is horizontally aligned with the upper pulley of sliding block 112. Adjustable mount 109b is mounted to the opposite end of control cable mount frame 108 and is horizontally aligned with the lower pulley of sliding block 112.

Now that the construction of the mechanism has been described, a preliminary centering adjustment must be performed. With handle bar 126 in the center position and the speed control in the zero speed position, sliding block with pulleys 112 will be at its closest position to control gear 101. At this time control cable adjustment mount 109a will be used to remove slack from control cable 111a just short of the point where it produces enough tension to expand return spring 107a and pull guide pin 104a off of adjustable stop 105a. Control cable mount 109b is used to follow the same procedure to adjust control cable 111b. At this point it must be noted that tension springs 110a and 110b produce more tension than return springs 107a and 107b. With the unit in this position, accurate speed control is performed by the above mentioned speed control mechanism. When sliding block with pulleys 112 moves away from control gear 101, the change in distance between sliding block with pulleys 112 and the above noted cable mounts increases and the pulleys rotate with the control cable travel to compensate for the change in distance thus pulling control arms 102a and 102b toward the forward end of control gear 101 which subsequently will end in equal rotational speed of the right and left drive wheels. Throughout this sequence, tension springs 110a and 110b will not expand due to lack of tension. Assuming the speed control mechanism is at full and control arms 102a and 102b are at their forward limit on control gear 101, if the handle bar 126 is rotated for left turn, control arm 102b will be held in the full position by its corresponding stop and tension spring 110b will expand to accommodate the additional length needed by control cable 111b to complete up to 20 degrees of additional rotation and the right drive wheel will maintain full speed. Simultaneously, the distance needed for control cable 111a will be reduced by an equivalent ratio and return spring 107a will pull control arm 102a toward the rear of control gear 101 and the speed of the left drive wheel will be reduced equivalent to how many degrees the handlebars 126 are turned to the left. A right turn at full speed control would be the inverse of this sequence. At zero speed if the handle bar 126 is turned either direction, the same above described sequence would occur at the rear end of control gear 101 but no motion will occur due to the further described power cutout system. Assuming the speed control mechanism is at 50%, the above described sequence of the control gear 101 will occur and as the handle bar 126 is rotated right or left, the control arms 102a and 102b will hover in place due to the cables moving around the rotating pulleys at a consistent tension and control gear 101 rotates in between them. Assuming the handle bar 126 is rotated either direction to a point where control arm 102a or 102b reaches the full speed position for the corresponding wheel, tension spring 110a or 110b will expand to accommodate the increase in length for the corresponding control cable to complete the additional 20 degrees of rotation if needed. The control arm position corresponding to the lower speed drive wheel will be limited from zero to 50%.

In summary, when the rotation of the handle bar exceeds the position of the speed control, the corresponding potentiometer will continue on a fixed position with the control gear and the tension spring compensates for the distance of the travel needed by the control cables.

A trimmer circuit bypasses the HMI mounted potentiometers and the trimmer potentiometers become the speed control when full speed control position is selected. The trimmer potentiometers are fixed mounted on a bracket in front of the handle bar and have control knobs. It is probable that two identical DC variable speed motors receiving the same level of current may have slight variation in speed which requires the operator to make constant adjustments to maintain a straight line of travel. This would also result in reduced ground speed over a line of travel. Adjusting the trimmer potentiometers will correct this. The circuit also allows the operated some full speed variation when calibrating a liquid or granule application.

When sliding block with pulleys 112 is moved to the full speed control position, said block makes contact with switch 116 and moves it to the closed position. Said switch transfers current to two poles of rotary switch 132. Rotary switch 132 is rotated at an equivalent ratio with handle bar 126 through cog belt 131 and pulleys 129 and 130. When handle bar 126 is positioned straight forward, both poles of rotary switch 132 are in the closed position. The two switches in rotary switch 132 will be noted as switch a, and switch b. When handle bar (26) is rotated left of the center position, switch a moves to the open position and switch b remains in the closed position throughout the 40 degree range of travel. When the handle bar 126 is rotated right of the center position, switch b moves to the open position and switch a remains in the closed position throughout the 40 degree range of travel. Switch a operates a 3 pole double throw relay noted as relay a. Switch b operates a 3 pole double throw relay noted as relay b. Relay a selects either variable potentiometer 103a or trimmer potentiometer 137a to be the control potentiometer for the PWM that controls the speed of the left wheel drive. Relay b selects either variable potentiometer 103b or trimmer potentiometer 137b to be the control potentiometer for the PWM that controls the speed of the right wheel drive.

In summary with the speed control at full and the handle bar in the center position, the right PWM and the left PWM are controlled by the trimmer potentiometers. When the handle bar is moved right or left of the center position at full speed control, the circuit will switch the lower speed wheel of the turn to the variable potentiometer.

The apparatus includes a power cutout circuit. It has 3 modes controlled by a 3 position switch mounted on a bracket in front of the handle bar. In the center position current to all drive circuits is switched off and all motion controls are disabled. In this mode the electric parking brakes on the right and left drive motors are engaged. With the switch in the manual position, power to all drive circuits is resumed when the speed control is advanced from the zero position and the electric brakes are controlled by a switch on the handle bar. In the auto mode the brakes are engaged and disengaged in tandem with the power cutout switch. When the speed control is moved to the zero position, the brakes will engage when power to the drive circuit is disengaged.

When sliding block with pulleys 112 is moved to the zero speed position, said block makes contact with switch 115 and moves it to the normally open position. When the speed control is advanced from the zero position, switch 115 moves to the closed position and transfers current to mode selector switch 135. When said switch is in the off position, it is the end of the circuit. When mode selector switch 135 is in the manual position, switch 115 becomes the control for the drive circuit power cutout relay. When speed control is at zero and switch 115 is open, the drive circuit power relay is disengaged. When the speed control advances from the zero position, switch 115 is moved to the closed position and the drive circuit power relay is engaged. With mode selector switch 135 in the manual position, current feed to the electric brakes is bypassed from switch 115 and handle bar switch 133 becomes the electric brake control. With mode selector switch 135 is in the auto position, switch 115 becomes the control for the drive circuit power cutout relay and the electric brake circuit. Handle bar switch 133 is bypassed in the auto mode.

The definition of remote and direct versions follow. In the direct version handle bar 126 is mounted to shaft 117. The handle bar is centered with the mechanism by using flange 128 and cog belt pulley 129 is mounted to shaft 117. In the direct version, control potentiometers 103a and 137a would be connected to the PWM that controls the right drive wheel mechanism and control potentiometers 103b and 137b would be connected to the PWM that controls the left drive wheel mechanism. The purpose of the remote version is to move the drive control assembly to another location that is required in the prototype vehicle due to space limitations. In the remote version handle bar 126, drive gear 124 and cog belt pulley 129 are mounted to shaft 125. In said version driven gear 120 is mounted to shaft 117 and the teeth of said gear mesh with the teeth of drive gear 124. Handle bar 126 are centered with regard to the drive control assembly by using flange 128.

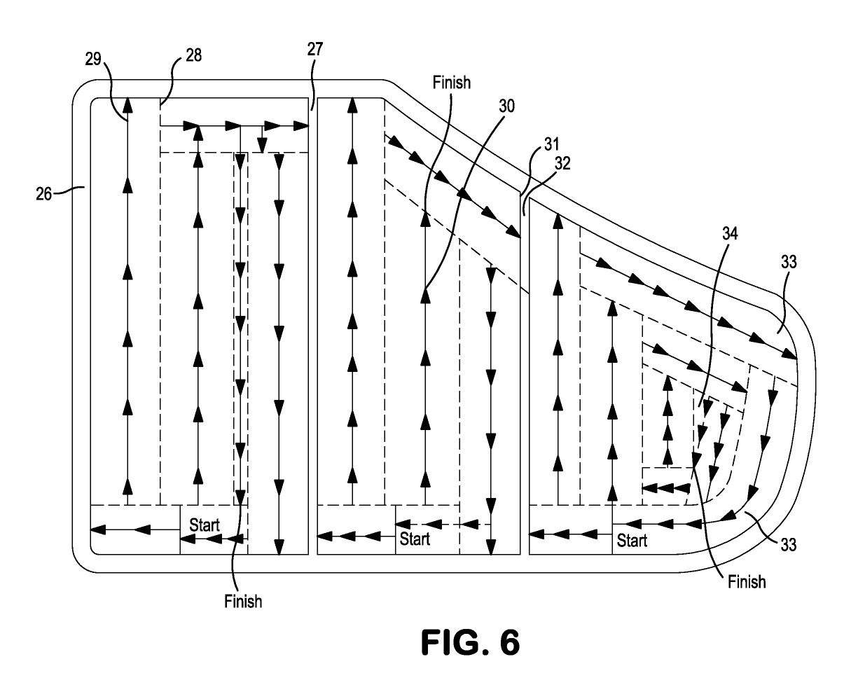

Turning finally to FIG. 6 that is an overhead view of an old Massachusetts cranberry bog, a procedure is depicted for the application of liquids and granules by the present invention. Many of the producing cranberry bogs in Massachusetts are 75-125 years old and were constructed with hand tools. They were planted in low lying peat swamps due to the fact that modern irrigation did not exist and ease of flooding was therefore a significant consideration. There is no standard geometry or size. Before mechanization this made little difference to hand labor. Each bog is surrounded by a perimeter drainage ditch 26 and interior drainage ditches 27 to assist with uniform soil moisture for the shallow rooted plants. Therefore there is no standard width for application apparatus. It is impossible to operate a vehicle or foot travel the crop bearing surface without disturbing the plants and the crop. More width is better to minimize the amount of passes needed to complete an individual section boarded by drainage ditches which minimizes wheel travel but the gross weight can be too much for the soft surface. Also controlling a wider system can be difficult in many situations. Cranberry plants are very sensitive to herbicides and fertilizers so applications must be as precise as possible. Applications are made by traveling the perimeter first and then boxing in the remainder. In the case of FIG. 6, it is done in the clockwise direction. In FIG. 6 dotted lines 28 simulate the inside of the band of one pass by the application unit. Solid lines with arrows 29 simulate the line and direction of travel. In most situations the final pass 30 is less than the full width of the application unit and must be filled in with maximum coverage and minimal overlap. Another situation that challenges the design of an application unit is the unit must align with obtuse or acute turning and position for the next pass. References 31 and 32 demonstrate the situation. This is why zero radius capability has an advantage by using less space and less overall wheel travel which minimizes surface contact. In other situations, there can be rounded areas (distances) 33 along the perimeter. In some cases a quick angled maneuver at the end of the pass will provide better uniformity 34. In other situations it may be better to follow the curve 33.

While the invention has been described, disclosed, illustrated and shown in various terms or certain embodiments or modifications which has assumed in practice, the scope of the invention is not intended to be, nor should it be deemed to be, limited thereby and such other modifications or embodiments as may suggested by the teachings herein are particularity reserved especially as they fall within the breadth and scope of the claims here appended.

What is claimed is:

1. A utility vehicle for agriculture and property maintenance landscaping comprising:
an electrically powered drive having two rear drive wheels and two forward freely swiveling castor wheels in which the drive wheels are powered by reversible gearhead motors and wherein direction is controlled by differential speed between the drive wheels;
a DC power supply having at least one storage battery to supply power to the gearhead motors;
a generator to supply power to the at least one storage battery, said generator powered by one of an internal combustion engine, an LG engine, and a LNG engine;
a main pay load area on which is mounted one of a tank for containing pesticide and the like, a cargo and product transport for transfer of liquids such as lubricants, pumps, and removal of waste liquids from any site with a self contained system, and
wherein the electrically powered drive allows extremely precise speed control.

2. The utility vehicle of claim 1 in which the vehicle is configured as a walk behind vehicle.

3. The utility vehicle of claim 1 which further comprises a steering apparatus having a motorcycle handle bar which pivots about an axis wherein a human machine interface controls the differential speed between the drive wheels.

4. The utility vehicle of claim 3 in which the handle bar supports a number of controls including a twist throttle for speed control and at least one switch for the electrical circuitry.

5. The utility vehicle of claim 3 in which the human machine interface further comprises two rotary potentiometers each of which control pulse width of a pulse width modulator to control the speed of a gearhead motor.

6. The utility vehicle of claim 5 in which the human machine interface further comprises a hall effect module interposed after the pulse width modulators to improve to achieve optimized speed control from the pulse width modulators.

7. The utility vehicle of claim 1 which further comprises the reversible gearhead motors connected through a sprocket and chain mechanism to the drive wheels.

8. The utility vehicle of claim 1 in which the tank is connected to spray apparatus on the vehicle.
